(19) United States
(12) Patent Application Publication
(10) Pub. No.: US 2014/0166830 A1
(43) Pub. Date: Jun. 19, 2014

(54) Gate Hugger - stabilization platform/equipment mounting bracket(s)

(71) Applicant: Harry James Billow, Columbia Falls, MT (US)

(72) Inventor: Harry James Billow, Columbia Falls, MT (US)

(73) Assignee: Harry James Billow

(21) Appl. No.: 13/694,644

(22) Filed: Dec. 19, 2012

(51) Int. Cl. B62D 33/027

(52) U.S. Cl. CPC B62D 33/0273
USPC 248/205.1

(57) ABSTRACT

Gate Hugger—stabilization platform and equipment mounting bracket(s). A new concept to enhance equipment applications used in conjunction with a pickup truck. A durable platform of welded steel components affixed atop the extreme rear of a pickup open tailgate. Anchoring chains at near corner locations on the front and rear faces of the platform adjust to maximum tightness to negate all movement of the stabilization platform. The rear face of the platform is implemented with the outside components of a three-part linear hinge configuration to establish attachment points for equipment. Mounting brackets have a steel channel segment bolted to equipment applications and the second segment being the center portion of the hinge configuration. A mounting bracket affixed to the stabilization platform is tightly interlocked and strengthened when the connection joint is completed by the insertion of a steel rod as the central chore of the hinge.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The pickup truck is used for its mobility to place materials and equipment convenient to the job site. The tailgate at the rear of a pickup truck bed is the access point to the cargo area and is itself often used as an elevated surface to complete work tasks on the job site. Therefore the tailgate is the interface of the work environment between the cargo area and the immediate job site.

The primary objective of this invention is to enhance equipment applications used in conjunction with a pickup truck. Affixing a stabilizing platform onto the rear of a pickup open tailgate provides a safe; free from doubt, attachment point for equipment. This attachment point for equipment is a strategic location to accomplish work tasks at the job site convenient to the cargo area of the pickup truck.

Another objective of this invention is to provide a stabilizing platform for equipment attachment that does not reduce the capacity of the cargo area, allows for its placement and removal without disrupting cargo, and may be affixed to the pickup tailgate permanently or use as needed basis without making alterations to the tailgate or pickup truck.

Another objective of this invention is to increase the versatility of a pickup truck by attaching equipment to the stabilization platform to increase options for cargo management, expand the cargo area, and increase the advantage of the pickup's mobility to complete work tasks.

### BRIEF SUMMARY OF THE INVENTION

The Gate Hugger stabilization platform is constructed of a pair of longitudinal, steel square channels welded to a plurality of crosswise connection channel of the same material A steel cover plate is welded to the top face of the frame to increase the durability of the platform.

Eye bolts are fastened at near corner positions on the front face of the stabilization platform. Chains extend from the eye bolts to allow anchoring of the platform to the tie downs at the rear of the cargo bed.

Rotating latch bars and rubber protection pads are bolted at near corner positions on the rear face of the stabilization platform. The latch bars are positioned to bridge the rear face of the pickup open tailgate, align the rear faces of the platform and tailgate, and negate forward movement of the platform. The latch bars are positioned to extend below the pickup open tailgate to allow attachment of an anchor chain between the latch bar and the pickup rear bumper.

The stabilization platform establishes three attachment point locations for equipment applications by welding aligned pairs of outer hinge members to the rear face of the platform at central and two lateral positions.

The outer hinge members are spaced apart to accommodate a center hinge member welded to the equipment mounting bracket. The hinge members complete a three-part linear hinge configuration and establish an interlocked attachment point.

An attachment or joint connection is completed between the stabilization platform and the mounting bracket by the insertion of a solid steel rod as the center core of the hinge.

### BRIEF DESCRIPTION OF THE SEVERAL VIEWS OF THE DRAWING

FIG. 1 is top view of the Gate Hugger stabilization platform frame and mounting bracket;

FIG. 2 is a perspective rear view of the stabilization platform, latch bars, protection pads, and ancoring chains;

FIG. 3 is an exploded view of the stabilization platform frame and the cover plate;

FIG. 4 is a perspective view illustration of a ramp attachment at a lateral location;

FIG. 5 is a side view illustration of three ramp attachments at functional positions, a ramp may be used as a raised boom or game hoist, when cabled toward the front of bed;

FIG. 6 is a perspective view illustration of a light weigth support, bolted to the step bumper of a pickup, used to reduce stress on the tailgate and connecting equipment applications;

FIG. 7 is a perspective view illustration of a heavy duty support, anchored to the step bumper or the main frame of the pickup truck;

FIG. 8 is a perspective view illustration of a scoop and lift, operated manually or by a winch and cable attached to the central lifting arm;

FIG. 9 is a perspective view of a bed extension, used in conjunction with a platform or supports positioned atop the side walls of a truck bed, to increase cargo area width and length for hauling an item such as a river raft;

FIG. 10 is a perspective view of a bed extension positioned on the same plane as the pickup bed floor and open tailgate and is used to expand the cargo area for hauling long length items such as a canoe;

FIG. 11 is a perspective view of a metal fence post driver manually operated with a rope passing over a pulley wheel and fasten to a weighted drop plunger;

FIG. 12 is a perspective view of a wood splitter manually operated with a rope passing over a pulley wheel and fasten to a weighted drop plunger.

### DETAILED DESCRIPTION OF THE INVENTION

The Gate Hugger stabilization platform is affixed upon the top surface and to the extreme rear of a pickup truck open tailgate. During use the greatest length of the stabilization platform and the tailgate are positioned parallel and adjacent to one another.

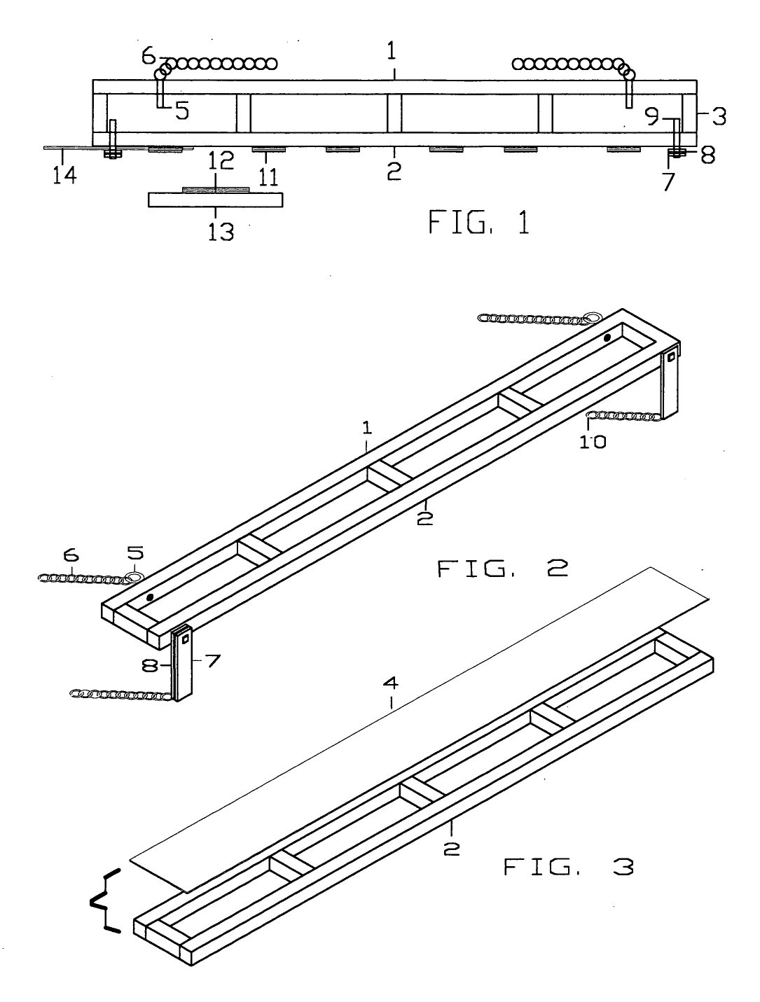

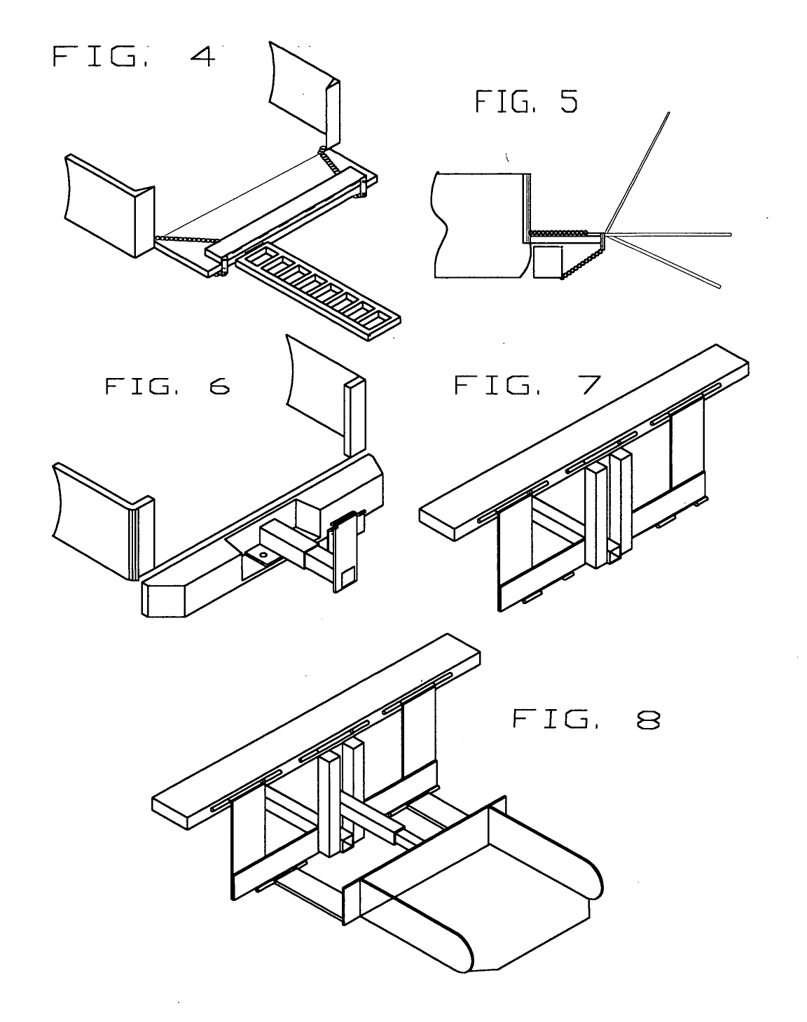

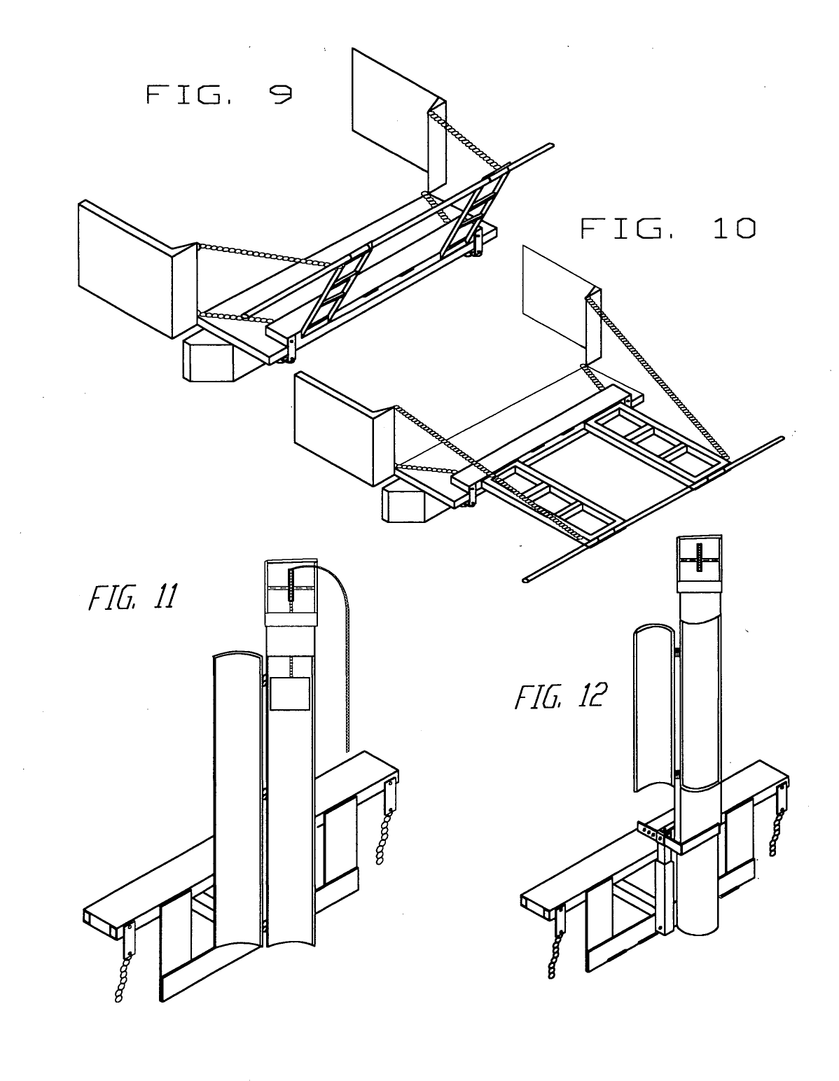

The welded frame of the Gate Hugger platform is constructed of 1¼ inch steel square channel. As shown in FIG. 1, five 3½ inch lengths of channel 3 are crosswise connected between two 54 inch channel 1,2. The 3½ inch lengths are positioned at ends, at center, and two locations half the distance from center to ends. The rectangular frame is 54 inches by 6 inches. In FIG. 3 a cover plate 4, a ⅛ inch steel plate the same dimension of the platform frame, is welded to the top face of the frame to increase the durability of the platform assembly.

As best shown in FIG. 1, the front face of the platform channel 1 is center drilled and a ½ inch eyebolt 5 is positioned six inches in from both ends. The eye bolt is placed with the threads and fastening nuts on the inside of the frame. As shown in FIG. 1, chains 6 extend from each eye bolt and anchor to the tie downs located at the rear of the pickup bed. Chain length is adjusted for maximum tightness to center and lock the platform securely affixed to the tailgate.

As best shown in FIG. 2, the rear face of the platform channel 2 is center drilled and a rotating latch bar 7 is positioned 1⅝ inches in from both ends. The 2×5×¼ inch metal latch bar is proportionally center drilled, through the greater surface area, at both ends. A 2×5×½ inch rubber pad 8 is proportionally center punched, through the greater surface area, at both ends. As shown in FIG. 1, a ½×3 inch bolt 9 is passed through one end of the latch bar and the rubber pad. The bolt continues to pass through the holes drilled in the rear face of the platform channel 2. The head of the bolt remains to the outside of the frame and the threads and fastening nuts are on the inside of the frame.

As best shown in FIG. 2, the latch bars 7 and rubber pads 8 position with the greater surface area prone and perpendicular to the rear face of the platform. The metal latch bars extend below the platform to bridge across the rear face of tailgate. The metal bars provide strength for the latch, hold the platform aligned with the rear face of the tailgate, and prevent the platform from forward movement. The rubber pads, ½ inch in thickness, protect the finish of the trucks tailgate.

As shown in FIG. 2, chains 10 extend from a hole drilled at the unbolted end of each latch bar and fasten to the adjacent truck bumper. These chains stop the platform and the tailgate from moving upwards and anchor the latch bar in position.

As shown in FIG. 2, the forward anchor chains 6 and the rear anchor chains 10 extend diagonally outward from near corner positions. The anchor chains adjust to maximum tightness to negate movement of the stabilization platform. The platform stabilized in position translates ultimate security to the attachment points for equipment applications.

The stabilization platform establishes three attachment point locations for equipment applications. As shown in FIG. 1, an aligned pair of three inch steel tubes 11, are welded to the rear channel 2 of the platform. Each pair forms the outside members of a three-part linear hinge configuration. The outer hinge members are spaced apart to accommodate the center hinge member of the configuration.

As shown in FIG. 1, a six inch length of steel tubing 12 is welded longitudinal to a 1¼×12 inch square steel channel 13 to form a mounting bracket. The steel tube segment forms the inside portion of the hinge configuration. The channel segment of the mounting bracket is bolted to an equipment application. One to three mounting brackets may be utilized for equipment applications used in conjunction with the stabilization platform affixed to the tailgate of a pickup truck .

Also shown in FIG. 1, a 24 inch length of solid steel rod 14 which inserts into the interior of the three tubes to complete an attachment or joint connection between the stabilization platform and the mounting bracket.

1. The Gate Hugger—Stabilization Platform and Equipment Mounting Bracket(s) comprising: a framed platform assembly with cover plate; to affix atop a pickup open tailgate and mounting bracket(s) for connecting equipment applications to the stabilization platform,

2. A platform assembly as in claim 1 comprising a mirrored pair of steel square channels on the same plane, wherein are welded to a plurality of crosswise connection channels of the same material on the identical plane,

3. A platform assembly as in claim 1 and further comprising a rectangular, steel plate welded to the top face of said platform to increase the durability of the platform.

4. A platform assembly as in claim 1 and further including a pair of symmetrical eyebolts, wherein are bolted at near corner positions, through the front face channel at the opposite ends of the platform.

5. The eyebolts as in claim 4 and further including one chain having first and second chain ends, said first chain end to fasten permanently to the eyebolt, and the said second chain end to fasten to the tiedowns at the rear floor of the pickup cargo bed.

6. A platform as in claim 1 and further including a symmetrical pair of rotatable latch bars and corresponding rubber protection pads, wherein are bolted at near corner positions, through the rear face channel at the opposite ends of the platform.

7. Each latch bar of claim 6 and further including one chain having first and second chain ends, said first chain end to fasten to the unbolted end of the latch bar, and the said second chain end to fasten to the bumper at the rear of the pickup.

8. The rubber protection pads of claim 6 wherein are positioned, between the latch bars and the rear face of the pickup tailgate, to reduce metal surface wear and slippage.

9. A platform as in claim 1 and further including three pairs of aligned steel tubes; one said pair welded to the rear face channel of the platform at central and two lateral locations; wherein each of said pair of steel tubes forms the outside members of a three-part linear hinge configuration.

10. The three-part liner hinge configuration of claim 9 wherein said pairs of aligned steel tubes are positioned to tightly receive the uniting center member, wherein establishing attachment locations for equipment connections.

11. An equipment mounting bracket as in claim 1 comprising a tubular channel segment welded longitudinal to a square channel segment, wherein the said tubular segment functions as the central member in of a hinge in association with the hinge configuration of claim 9.

12. An equipment mounting bracket as in claim 1 and further comprising a square channel segment, wherein is bolted to equipment applications for mounting to the stabilization platform.

13. An equipment mounting bracket(s) as in claim 1 is further interlocked, strengthened, and held in alignment at the established attachment point(s) of claim 8; wherein a solid steel rod inserted through the interior core of the three-part hinge, whereby completes a convenient attachment or joint connection to the stabilization platform.

14. An equipment mounting bracket(s) as in claim 1 whereby negated from horizontal movement due to the interlocked hinge, wherein allows equipment to pivot vertically, perpendicular to the joint configuration and stabilization platform.

15. The Gate Hugger—Stabilization Platform and Equipment Mounting Bracket(s) enhance equipment applications used in conjunction with a pickup truck by establishing safe, free from doubt, attachment point(s) for equipment at a strategic location to accomplish work tasks at the job site convenient to the cargo area.

16. The stabilization platform and equipment mounting brackets of claim 15 and further increases the versatility of a pickup truck by attaching equipment to increase options for cargo management, expand the cargo area, and increase the advantage of the pickup's mobility to complete work tasks.
